(19) United States
(12) Patent Application Publication
(10) Pub. No.: US 2024/0310575 A1
(43) Pub. Date: Sep. 19, 2024

(54) OPTICAL FIBER CONNECTION STRUCTURE AND MANUFACTURING METHOD THEREOF

(71) Applicant: FURUKAWA ELECTRIC CO., LTD., Tokyo (JP)

(72) Inventors: Yusuke MATSUNO, Tokyo (JP); Masanori TAKAHASHI, Tokyo (JP); Ryuichi SUGIZAKI, Tokyo (JP); Akio TANABE, Tokyo (JP); Yoshihiro ARASHITANI, Tokyo (JP)

(73) Assignee: FURUKAWA ELECTRIC CO., LTD., Tokyo (JP)

(21) Appl. No.: 18/604,728

(22) Filed: Mar. 14, 2024

(30) Foreign Application Priority Data
Mar. 17, 2023 (JP) 2023-042795
Mar. 6, 2024 (JP) 2024-033557

(51) Int. Cl. G02B 6/02; G02B 6/255

(52) U.S. Cl. CPC G02B 6/021; G02B 6/02042; G02B 6/2551

(57) ABSTRACT

An optical fiber connection structure includes a first optical fiber and a second optical fiber each including plural cores and a cladding surrounding outer peripheries of the plural cores, the first optical fiber and the second optical fiber being connected to each other at end faces of the first optical fiber and the second optical fiber, arrangements of the plural cores of the first optical fiber and the second optical fiber matching each other at least partly.

### CROSS-REFERENCE TO RELATED APPLICATION (S)

This application claims the benefit of priority from Japanese Patent Application No. 2023-042795 filed on Mar. 17, 2023 and Japanese Patent Application No. 2024-033557 filed on Mar. 6, 2024, the entire contents of which are incorporated herein by reference.

### BACKGROUND

### 1. Technical Field

The present disclosure relates to an optical fiber connection structure and a method of manufacturing the optical fiber connection structure.

### 2. Related Art

Multicore fibers have recently been used not only for communication lines but also for components. Such multicore fibers have increasingly been made to have a core arrangement of a plural layered structure that achieves high capacity traffic per optical fiber. A multicore fiber is an optical fiber including plural cores and common cladding surrounding outer peripheries of the plural cores. A structure described in Japanese Unexamined Patent Application Publication No. 2019-152866 has been disclosed as a connection structure having multicore fibers connected to each other.

Furthermore, bundle-type optical fibers have been known as optical fibers each including plural cores. A bundle-type optical fiber is an optical fiber formed of single core optical fibers bundled together in a predetermined arrangement, the single core optical fibers each including a single core and cladding surrounding an outer periphery of the single core. A structure described in International Publication Pamphlet No. WO 2012/121320 has been disclosed as a connection structure having a multicore fiber and a bundle-type optical fiber connected to each other.

Furthermore, in a technique disclosed in Japanese Unexamined Patent Application Publication No. 2004-163755, the technique being for connecting optical fibers together, the optical fibers having mode field diameters different from each other, increasing the mode field diameter of one of these optical fibers and fusion splicing are performed at a single fusion splicing apparatus.

### SUMMARY

In a case where two optical fibers are connected to each other, the two optical fibers each having two or more cores at mutually different distances in a radial direction from the central axis of the optical fiber, if a relative rotation error is generated about the central axes of the two optical fibers, the following problem occurs. That is, for two cores at mutually different distances in the radial direction from the central axis, the same rotation error results in mutually different amounts of misalignment in a circumferential direction about the axis. As a result, the core nearer to the central axis and the core farther from the central axis have different connection losses resulting from the rotation error. This difference between the connection losses undesirably causes differences in transmission characteristics between the two cores.

The present disclosure is made in view of the above and an object thereof is to provide an optical fiber connection structure and a method of manufacturing the optical fiber connection structure that enable reduction in a difference between connection losses even for cores at different distances in the radial direction from their central axis.

One aspect of the present disclosure is an optical fiber connection structure including a first optical fiber and a second optical fiber each including plural cores and a cladding surrounding outer peripheries of the plural cores, the first optical fiber and the second optical fiber being connected to each other at end faces of the first optical fiber and the second optical fiber, arrangements of the plural cores of the first optical fiber and the second optical fiber matching each other at least partly. The plural cores include a first core and a second core that is farther from a central axis of the cladding than the first core, and the second core has a mode field diameter larger than a mode field diameter of the first core in at least a connection region near the end faces.

One aspect of the present disclosure is a method of manufacturing the optical fiber connection structure, the method including: a process of causing an end face of the first optical fiber and an end face of the second optical fiber to face each other and performing electric discharge near the end faces faced each other. In the performing the electric discharge, a range where an additive included in the second core to increase a refractive index of the second core is diffused in a radial direction of the second core is made wider than a range where an additive included in the first core to increase a refractive index of the first core is diffused in a radial direction of the first core.

What has been stated above, as well as other features, advantages, and technical and industrial significance of the present disclosure will be understood further as the following detailed description is read in light of the appended drawings.

### BRIEF DESCRIPTION OF THE DRAWINGS

FIG. 1 is a schematic sectional view for a cross section perpendicular to a longitudinal direction of an optical fiber connected in an optical fiber connection structure according to a first embodiment;

FIG. 2 is a schematic sectional view for a cross section along a longitudinal direction of the optical fiber connection structure according to the first embodiment;

FIG. 3 is a diagram illustrating a rotation error at a connection in the optical fiber connection structure;

FIG. 4 is a diagram illustrating an example of a relation between rotation error and connection loss;

FIG. 5 is a diagram illustrating an example of a relation between rotation error and mode field diameter;

FIG. 6 is a diagram illustrating an example of a relation between rotation error and mode field diameter;

FIG. 7 is a diagram illustrating an example of a method of manufacturing the optical fiber connection structure according to the first embodiment;

FIG. 8 is a diagram illustrating an example of another method of manufacturing the optical fiber connection structure according to the first embodiment;

FIG. 9 is a diagram illustrating an example of yet another method of manufacturing the optical fiber connection structure according to the first embodiment;

FIG. 10 is a schematic sectional view for a cross section perpendicular to a longitudinal direction of an optical fiber connected in an optical fiber connection structure according to a second embodiment; and

FIG. 11 is a schematic sectional view for a cross section perpendicular to a longitudinal direction of an optical fiber connected in an optical fiber connection structure according to a third embodiment.

### DETAILED DESCRIPTION

Embodiments of the present disclosure will be described in detail hereinafter while reference is made to the appended drawings. The present disclosure is not to be limited by the embodiments described hereinafter. Furthermore, throughout the drawings, any components that are the same or corresponding to each other will be assigned with the same reference sign, as appropriate. Furthermore, any term not particularly defined in this specification conforms to the definitions and measurement methods according to G. 650.1 and G. 650.2 of the International Telecommunication Union (ITU).

### First Embodiment

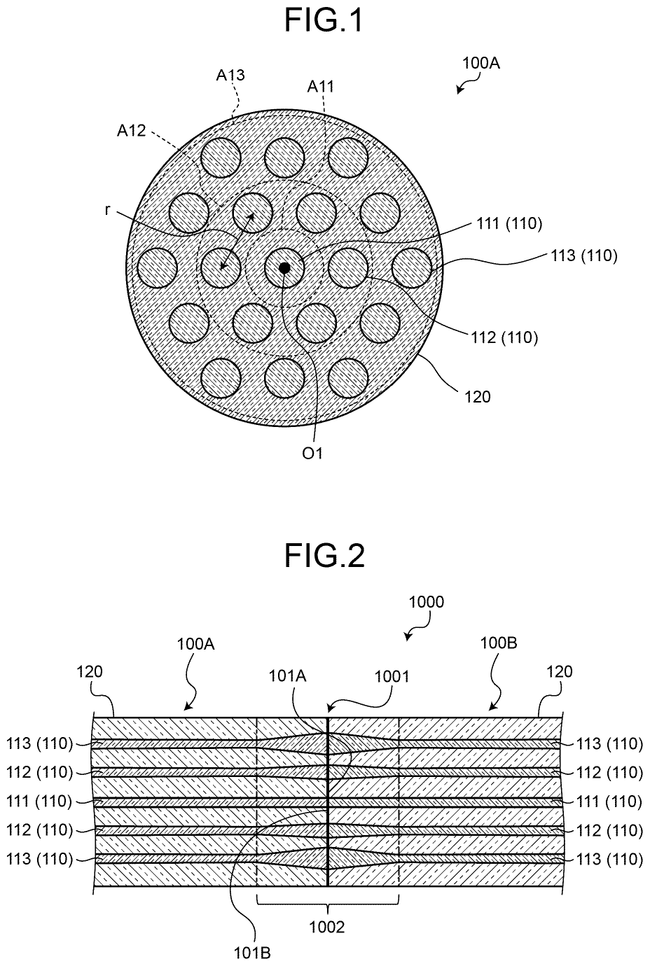

FIG. 1 is a schematic sectional view for a cross section perpendicular to a longitudinal direction of an optical fiber 100A connected in an optical fiber connection structure according to a first embodiment. The optical fiber 100A is a multicore fiber made of silica-based glass and includes 19 cores 110 and a common cladding 120 surrounding outer peripheries of the cores 110. The 19 cores 110 are an example of plural cores. The cores 110 have an additive, such as germanium, added therein, to increase their refractive index in relation to the cladding 120. The cores 110 have been arranged in a triangular lattice form on the cross section perpendicular to the longitudinal direction of the optical fiber 100A. The cores 110 have a core pitch of r, which is a distance between centers of the cores 110. The optical fiber 100A is also called a 19-core multicore fiber.

The cladding 120 has areas A11, A12, and A13 prescribed on any cross section perpendicular to the longitudinal direction of the optical fiber 100A. The area A11 is a circular area nearest to a central axis O1 of the optical fiber 100A, the central axis O1 also being a central axis of the cladding 120, the circular area including the central axis O1. The area A12 is a ring-shaped area that is farther from the central axis O1 than the area A11, the ring-shaped area surrounding an outer periphery of the area A11. The area A13 is a ring-shaped area that is farther from the central axis O1 than the area A12, the ring-shaped area surrounding an outer periphery of the area A12.

The cores 110 include cores 111, 112, and 113. Specifically, one core 111 having a central axis that approximately coincides with the central axis O1 of the optical fiber 100A is present in the area A11. Six cores 112 arranged in a regular hexagon shape about the central axis O1 are present in the area A12. Twelve cores 113 arranged in a regular hexagon shape about the central axis O1 are present in the area A13. Therefore, the cores 112 are each farther from the central axis O1 than the core 111. Furthermore, the cores 113 are each farther from the central axis O1 than the core 111 and the cores 112.

FIG. 2 is a schematic sectional view for a cross section along a longitudinal direction of an optical fiber connection structure 1000 according to the first embodiment. The optical fiber connection structure 1000 has the optical fiber 100A illustrated in FIG. 1 and an optical fiber 100B having the same configuration as the optical fiber 100A connected to each other by fusion splicing at an end face 101A of the optical fiber 100A and an end face 101B of the optical fiber 100B. A connection portion 1001 is a portion formed by the fusion splicing between the end face 101A of the optical fiber 100A and the end face 101B of the optical fiber 100B. The optical fiber 100A is an example of a first optical fiber and the optical fiber 100B is an example of a second optical fiber.

The optical fiber 100A and the optical fiber 100B have the same configuration and an arrangement of the cores 110 of the optical fiber 100A and an arrangement of cores 110 of the optical fiber 100B thus match each other. Therefore, in the optical fiber connection structure 1000, the core 111 of the optical fiber 100A and a core 111 of the optical fiber 100B are connected to each other by fusion splicing, the cores 112 and cores 112 thereof are connected to each other by fusion splicing, and the cores 113 and cores 113 thereof are connected to each other by fusion splicing.

In at least a connection region 1002 near the end faces 101A and 101B, the cores 112 present in their areas A12 have mode field diameters larger than mode field diameters of the cores 111 present in their areas A11. In this case, the areas A11 are an example of first areas, the areas A12 are an example of second areas, the cores 111 are an example of first cores, and the cores 112 are an example of second cores.

Furthermore, in the connection region 1002, the cores 113 present in their areas A13 have mode field diameters larger than the mode field diameters of the cores 111 present in the areas A11. In this case, the areas A11 are an example of first areas, the areas A13 are an example of second areas, the cores 111 are an example of first cores, and the cores 113 are an example of second cores.

Furthermore, in the connection region 1002, the mode field diameters of the cores 113 present in the areas A13 are larger than the mode field diameters of the cores 112 present in the areas A12. In this case, the areas A12 are an example of first areas, the areas A13 are an example of second areas, the cores 112 are an example of first cores, and the cores 113 are an example of second cores.

However, in a region farther from the connection portion 1001 than the connection region 1002 is in the optical fiber connection structure 1000, all of the cores 110 have mode field diameters that are approximately equal to one another.

Examples of a configuration for achieving such mode field diameters in the optical fiber connection structure 1000 include a configuration having a wider range in a radial direction of a second core, the wider range being wider than a range in a radial direction of a first core and being where an additive included in the second core to increase its refractive index is present, the range being where an additive included in the first core to increase its refractive index is present. These additives to increase the refractive indices are, for example, germanium.

As described above, in the connection region 1002 of the optical fiber connection structure 1000, a second core present in a second area at a distance farther from the central axis O1 has a mode field diameter larger than a mode field diameter of a first core at a distance nearer from the central axis O1. As a result, a core that is more misaligned in a circumferential direction about an axis has a larger mode field diameter in the connection region 1002 and a difference between connection losses in cores at mutually different distances in a radial direction from a central axis is thus able to be reduced.

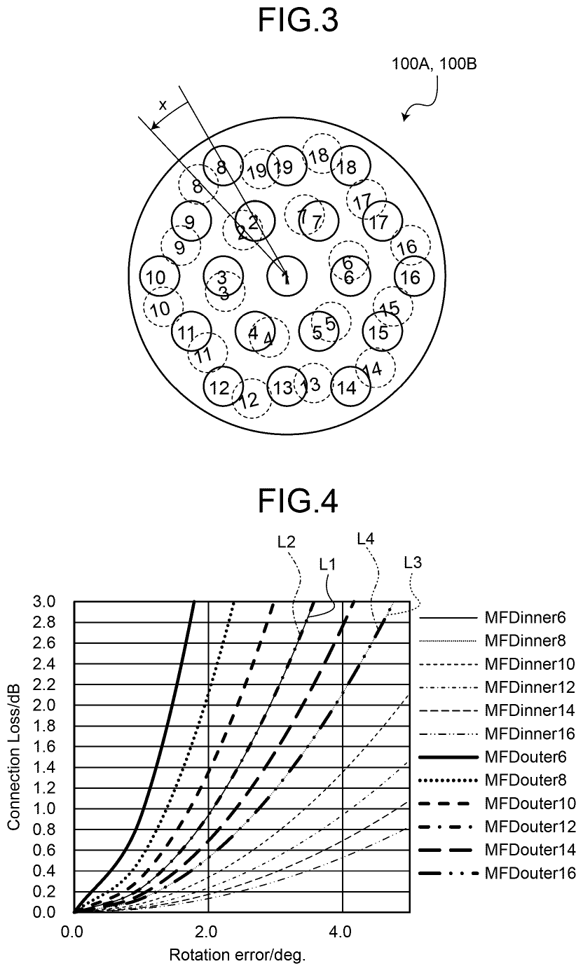

FIG. 3 is a diagram illustrating a rotation error at a connection in the optical fiber connection structure. FIG. 3 illustrates a case where an amount of a rotation error about a central axis is x degrees at the connection portion 1001 of the optical fiber 100A and optical fiber 100B. Hatching has been omitted in FIG. 3 and the cores have been numbered therein for the sake of description. Solid lined circles represent the cores of the optical fiber 100A and broken lined circles represent the cores of the optical fiber 100B.

As illustrated in FIG. 3, cores numbered 1 are present near the central axes of the optical fiber 100A and optical fiber 100B and thus have little misalignment in the circumferential direction about the axis resulting from the rotation error. By contrast, for example, cores numbered 2 are the cores 112 present in the areas A12 and have large misalignment in the circumferential direction about the axis resulting from the rotation error. Furthermore, for example, cores numbered 8 are the cores 113 present in the areas A13 and have even larger misalignment in the circumferential direction about the axis resulting from the rotation error.

FIG. 4 is a diagram illustrating an example of a relation between rotation error and connection loss. The horizontal axis corresponds to rotation error and the vertical axis to connection loss. In the legends, for example, “MFDinner6” refers to a case where cores present in the areas A12 (cores numbered 2 to 7) that are inner areas have a mode field diameter of 6 μm at a wavelength of 1550 nm. Furthermore, for example, “MFDouter6” refers to a case where cores present in the areas A13 (cores numbered 8, 10, 12, 14, 16, and 18) have a mode field diameter of 6 μm at the wavelength of 1550 nm. Furthermore, the core pitch r is 40 μm. Therefore, distances from the central axes of their cladding (the central axes of the cores numbered 1) to the central axes of the cores numbered 2 to 7 are 40 μm, and distances from the central axes of their cladding (the central axes of the cores numbered 1) to the central axes of the cores numbered 8, 10, 12, 14, 16, and 18 are 80 μm. Therefore, in the case of FIG. 3 and FIG. 4, the distances from the central axis O1 to the central axes of the cores numbered 8, 10, 12, 14, 16, and 18 are twice the distances from the central axis O1 to the central axes of the cores numbered 2 to 7.

As illustrated in FIG. 4, a curve L1 for the case of “MFDinner6” and a curve L2 for a case of “MFDouter12 coincide with each other. The case of “MFDinner6” is the case where the mode field diameters of the cores numbered 2 to 7 are 6 μm and the case of “MFDouter12” is a case where the cores numbered 8, 10, 12, 14, 16, and 18 have a mode field diameter of 12 μm. Furthermore, a curve L3 for a case of “MFDinner8” and a curve L4 for a case of “MFDouter16” coincide with each other. The case of “MFDinner8” is a case where the mode field diameters of the cores numbered 2 to 7 are 8 μm and the case of “MFDouter16 is a case where the cores numbered 8, 10, 12, 14, 16, and 18 have a mode field diameter of 16 μm. This indicates that their connection losses are able to be matched with each other if the mode field diameter of the cores numbered 8, 10, 12, 14, 16, and 18 having their central axes at a predetermined distance from the central axis O1 is twice the mode field diameter of the cores numbered 2 to 7 having their central axes at a distance that is ½ of the predetermined distance from the central axis O1.

The following two equations hold at the wavelength of 1550 nm where “Loss” (dB) is a connection loss, R (μm) is a distance between the central axis of a core and the central axis of the cladding portion, and MFD (μm) is a mode field diameter of the core (see D. Marcuse, “Loss analysis of single-mode fiber splice,” Bell Syst. Tech. J. vol. 56, pp. 703-718 (1977)).

$$\begin{matrix}Loss = - 10 \cdot log ( exp ( - {d}^{2} / {( MFD / 2 )}^{2} ) ) \\ d = π \cdot R \cdot x / 180\end{matrix}$$

The following equation is derived from the above two equations. Herein, e is the base of natural logarithms.

$$MFD = 2 √ ( ( 10 / Loss ) \cdot log ( e ) ) \cdot ( π \cdot R \cdot x / 180 )$$

Therefore, an MFD satisfying Expression 1 below achieves a connection loss equal to or less than any value of “Loss” (dB).

$$MFD \geq 2 √ ( ( 10 / Loss ) \cdot log ( e ) ) \cdot ( π \cdot R \cdot x / 180 ) \qquad ( 1 )$$

Furthermore, if R is expressed using the core pitch r, R=r for the cores numbered 2 to 7 and R=2·r for the cores numbered 8, 10, 12, 14, 16, and 18.

Therefore, if Expressions 2 and 3 below hold at the wavelength of 1550 nm and in at least a range of 6 μm≤MFD1<MFD2≤16 μm, a connection loss of 1.5 dB or less is able to be achieved, where “MFD1” is the mode field diameter of the cores numbered 2 to 7 and “MFD2” is the mode field diameter of the cores numbered 8, 10, 12, 14, 16, and 18.

$$MFD 1 \geq 2 √ ( ( 10 / 1.5 ) \cdot log ( e ) ) \cdot ( π \cdot r \cdot x / 180 ) \qquad ( 2 )$$

$$MFD 2 \geq 4 √ ( ( 10 / 1.5 ) \cdot log ( e ) ) \cdot ( π \cdot r \cdot x / 180 ) \qquad ( 3 )$$

FIG. 5 is a diagram illustrating an example of a relation between rotation error and mode field diameter (MFD). For Expression 3, when R=40 μm and Loss=1.5 dB, a line, “Inner”, in FIG. 5 is obtained. Furthermore, For Expression 3, when R=80 μm and Loss=1.5 dB, a line, “Outer”, in FIG. 5 is obtained. Furthermore, in FIG. 5, a line L5 represents a line for a mode field diameter of 6 μm and a line L6 represents a line for a rotation error of 1.27 degrees. Therefore, in at least a range where the MFD is 6 μm or larger and 16 μm or smaller, connection losses in the cores numbered 8, 10, 12, 14, 16, and 18 are able to be made 1.5 dB or less if the mode field diameters are in an area on and above the line, “Outer”. Furthermore, in at least the range where the MFD is 6 μm or larger and 16 μm or smaller, connection losses in the cores numbered 2 to 7 are able to be made 1.5 dB or less if the mode field diameters are in an area on and above the line, “Inner”. Furthermore, for the cores numbered 8, 10, 12, 14, 16, and 18, in a case where the mode field diameters are 6 μm, the rotation error needs to be made 1.27 degrees or less to achieve connection losses of 1.5 dB or less.

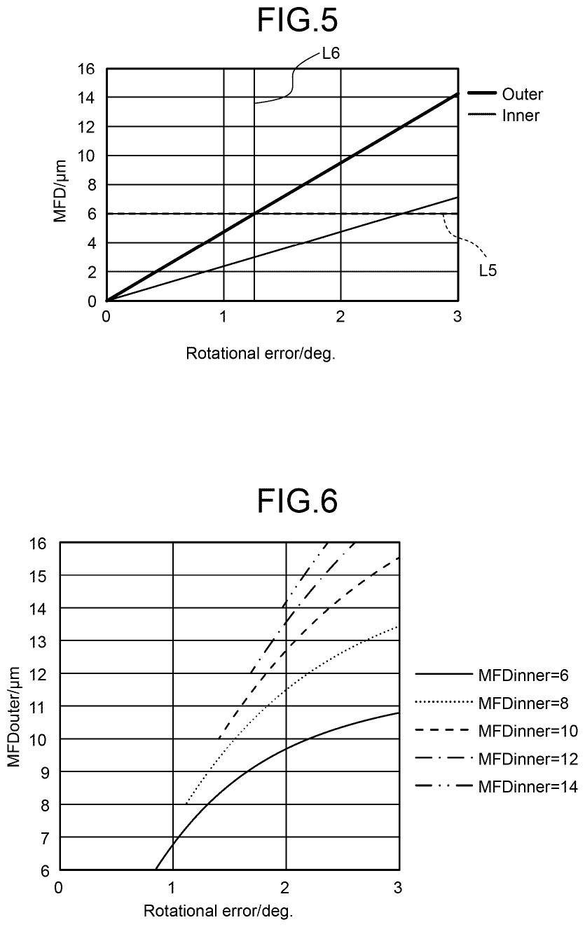

FIG. 6 is a diagram illustrating an example of a relation between rotation error and mode field diameter (MFD). Specifically, FIG. 6 illustrates lower limits of mode field diameters corresponding to the numbers 8, 10, 12, 14, 16, and 18 in a case where the mode field diameters of the cores numbered 2 to 7 have values between 6 μm and 16 μm, the mode field diameters corresponding to the numbers 8, 10, 12, 14, 16, and 18 resulting in a difference of 0.5 dB between a connections loss in the cores numbered 2 to 7 and a connections loss in the cores numbered 8, 10, 12, 14, 16, and 18. For example, “MFDinner=6” in the legends represents a line for the lower limit of the mode field diameters (MFDouter) corresponding to the numbers 8, 10, 12, 14, 16, and 18, the mode field diameters (MFDouter) resulting in a difference of 0.5 dB between a connection loss in the cores numbered 2 to 7 and a connections loss in the cores numbered 8, 10, 12, 14, 16, and 18 in a case where the cores numbered 2 to 7 have a mode field diameter of 6 μm. Therefore, if “MFDouter” is in an area on or above a line corresponding to values of “MFDinner” in FIG. 6, a difference of 0.5 dB or less is able to be achieved between the connection losses.

However, as understood from FIG. 4, if the mode field diameter of a second core is too much larger than the mode field diameter of a first core, the difference between their connection losses may be increased. For example, the mode field diameter of a second core is preferably 1.8 times or more and 2.2 times or less the mode field diameter of a first core.

In this embodiment, the length of the connection region 1002 is not particularly limited, but if the connection region 1002 is too long, the large mode field diameters in the connection region 1002 may increase the cross talk between the cores and the bending loss. Therefore, an adequate length of the connection region 1002 is, for example, about 1 mm to 5 mm. Furthermore, because the number of cores adjacent to and around a core 110 that is present more inward like those in the area A11 and area A12 is large, the total value of cross talk between the cores tends to become large when the mode field diameters are large. Therefore, the mode field diameters of the cores 110 that are present more outward are preferably set largely without the mode field diameters of the cores 110 that are present more inward being set too largely.

### Method of Manufacturing Optical Fiber Connection Structure

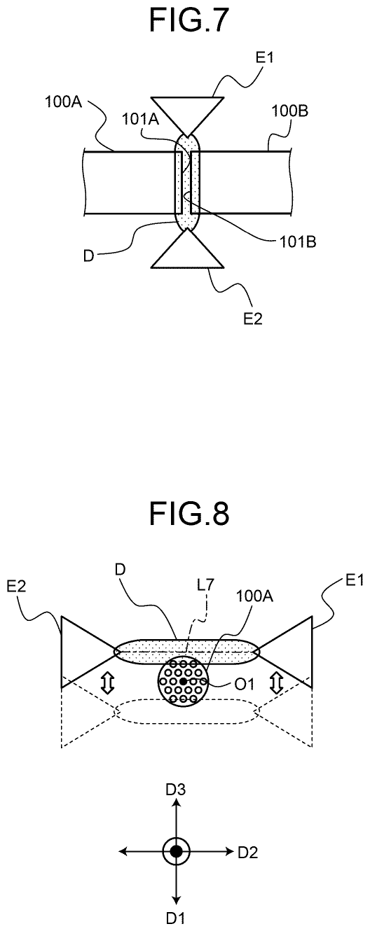

The optical fiber connection structure 1000 according to the embodiment can be implemented using a publicly known fusion splicing apparatus, as illustrated in FIG. 7, for example. That is, the end face 101A of the optical fiber 100A and the end face 101B of the optical fiber 100B are faced each other, and fusion splicing is performed by executing a process of performing electric discharge D from a pair of electrodes E1 and E2 to a region near the end faces 101A and 101B faced each other. Imparting thermal energy to the region near the end faces 101A and 101B by the electric discharge D causes the additive included in each core of the optical fiber 100A and optical fiber 100B to diffuse in a radial direction of the core, the additive being an additive to increase the refractive index, and the mode field diameter is increased in association therewith. In the process of performing the electric discharge, making a range where the additive included in the second core diffuses in a region serving as the connection region 1002 wider than a range where the additive included in the first core diffuses in the region enables increase in mode field diameters so that the mode field diameter of the second core becomes larger than the mode field diameter of the first core, the first core being at a distance closer from the central axis of the cladding, the second core being at a distance farther from the central axis of the cladding.

Furthermore, intermittent discharge may be performed in the process of performing electric discharge. Performing the intermittent discharge results in formation of a state where a region near outer peripheral surfaces of the optical fibers 100A and 100B has a high temperature, although fusion splicing between the optical fiber 100A and optical fiber 100B is not achieved by just a single short electric discharge. In this state, as a single electric discharge is finished, the temperature of the optical fibers 100A and 100B decreases sharply and it is thus difficult for the heat to be conducted toward a region near the central axes of the optical fibers 100A and 100B. Repeating such an electric discharge intermittently enables outer peripheral regions of the optical fibers 100A and 100B to be more effectively heated than the region near the central axes of the optical fibers 100A and 100B. As a result, the mode field diameters are able to be increased so that the mode field diameter of a second core becomes larger than the mode field diameter of a first core.

As to settings for the intermittent discharge, for example, the discharging current is set to 15 mA to 30 mA when the electric discharge is on, the on-time period of the electric discharge is set to 10 ms to 30 ms, and the off-time period of the electric discharge is set to 40 mA to 100 mA but the settings are not limited to these numerical values.

Furthermore, the process of performing electric discharge may be done as illustrated in FIG. 8. FIG. 8 is a diagram illustrating another example of the method of manufacturing the optical fiber connection structure 1000 according to the first embodiment and is a diagram of the end face of the optical fiber 100A as viewed from the end face of the optical fiber 100B. A direction D1 in FIG. 8 is the longitudinal direction of the optical fibers 100A and 100B. A direction D2 is a direction orthogonal to the direction D1 and is an arrangement direction of the pair of electrodes E1 and E2. A direction D3 is a direction orthogonal to the directions D1 and D2.

In FIG. 8, as indicated by double-headed arrows, the pair of electrodes E1 and E2 for electric discharge are caused to reciprocate in the direction (direction D3) orthogonal to the longitudinal direction of the optical fibers 100A and 100B. Thermal energy Q1 to be imparted to the region near the central axes (the central axis O1 in FIG. 8) of the optical fibers 100A and 100B is thereby made lower than thermal energy Q2 to be imparted to a position away from the central axis O1 in the direction D3. The direction D3 is an example of a reciprocating direction. As a result, the mode field diameters are able to be increased so that a mode field diameter of a second core become larger than a mode field diameter of a first core. Q1 is able to be more effectively made smaller than Q2 by, for example, increasing the moving velocity or decreasing the discharging current when the center (indicated by a line L7) of the electric discharge from the electrodes E1 and E2 passes the region near the central axis O1. Decreasing the discharging current includes making the discharging current zero.

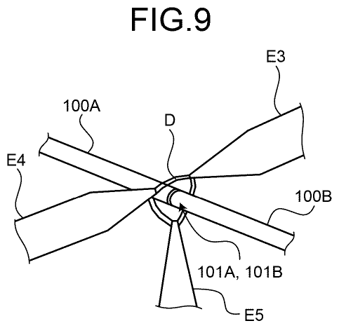

Furthermore, the process of performing electric discharge may be done as illustrated in FIG. 9. FIG. 9 is a diagram illustrating another example of the method of manufacturing the optical fiber connection structure 1000 according to the first embodiment. In FIG. 9, electric discharge is performed by arranging a group of three electrodes E3, E4, and E5 for electric discharge to surround the end faces 101A and 101B of the optical fibers 100A and 100B, the end faces 101A and 101B having been faced each other. The mode field diameters are thereby able to be increased so that the mode field diameter of a second core become larger than the mode field diameter of a first core because the electric discharge D is formed to surround the end faces 101A and 101B.

Intermittent discharge for on-off repetition may be performed by the group of three electrodes E3, E4, and E5 illustrated in FIG. 9. The outer peripheral regions of the optical fibers 100A and 100B are thereby able to be more effectively heated than the region near the central axes of the optical fibers 100A and 100B, similarly to the case of electric discharge using a pair of two electrodes (also referred to as bipolar electric discharge).

Furthermore, instead of maintaining the discharging current constant during the discharge period using the group of three electrodes E3, E4, and E5, periodicity (for example, a sine period) may be provided in the change of electric current and the electric discharge may be increased and decreased by temporally changing the intensity of the electric discharge. The temperature change in the radial direction of the optical fibers is able to be made more gradual than that when the electric discharge is simply turned on and off repeatedly and the amounts of change in mode field diameters of inner cores and outer cores are able to be controlled more finely.

Furthermore, a group of electrodes including the three electrodes E3, E4, and E5 are used in FIG. 9, but the group of electrodes may include four or more electrodes.

### Other Embodiments

The optical fiber 100A connected in the optical fiber connection structure 1000 according to the first embodiment is a 19-core multicore fiber, but a multicore fiber having another structure may be connected in an optical fiber connection structure according to another embodiment.

FIG. 10 is a schematic sectional view for a cross section perpendicular to a longitudinal direction of an optical fiber 200A connected in an optical fiber connection structure according to a second embodiment. The optical fiber 200A is a multicore fiber made of silica-based glass and includes seven cores 210 and common cladding 220 surrounding outer peripheries of the cores 210. The seven cores 210 are an example of plural cores. The cores 210 have an additive, such as germanium, added therein, to increase their refractive index in relation to the cladding 220. The cores 210 are arranged in a triangular lattice form on the cross section perpendicular to the longitudinal direction of the optical fiber 200A. The optical fiber 200A is also called a 7-core multicore fiber.

The cladding 220 has areas A21 and A22 prescribed on any cross section perpendicular to the longitudinal direction of the optical fiber 200A. The area A21 is a circular area nearest to a central axis O2 of the optical fiber 200A, the central axis O2 also being a central axis of the cladding 220, the circular area including the central axis O2. The area A22 is a ring-shaped area that is farther from the central axis O2 than the area A21, the ring-shaped area surrounding an outer periphery of the area A21.

The cores 210 include cores 211 and 212. Specifically, one core 211 having a central axis that approximately coincides with the central axis O2 of the optical fiber 200A is present in the area A21. Six cores 212 arranged in a regular hexagon shape about the central axis O2 are present in the area A22.

The optical fiber connection structure according to the second embodiment has the optical fiber 200A illustrated in FIG. 10 and an optical fiber having the same configuration as the optical fiber 200A connected to each other at their end faces by fusion splicing. The optical fiber 200A and the optical fiber connected to the optical fiber 200A by fusion splicing have the same configuration and arrangements of their cores thus match each other.

In a connection region near the end faces connected by fusion splicing in the optical fiber connection structure according to second embodiment also, mode field diameters of their cores 212 present in their areas A22 are larger than mode field diameters of their cores 211 present in their areas A21. In this case, the areas A21 are an example of first areas, the areas A22 are an example of second areas, the cores 211 are an example of first cores, and the cores 212 are an example of second cores.

However, in a region farther from a connection portion than the connection region is in the optical fiber connection structure according to the second embodiment, the cores 210 have approximately equal mode field diameters.

In the optical fiber connection structure according to the second embodiment also, similarly to the first embodiment, the difference between the connection losses is able to be reduced even for cores at different radial distances from the central axis.

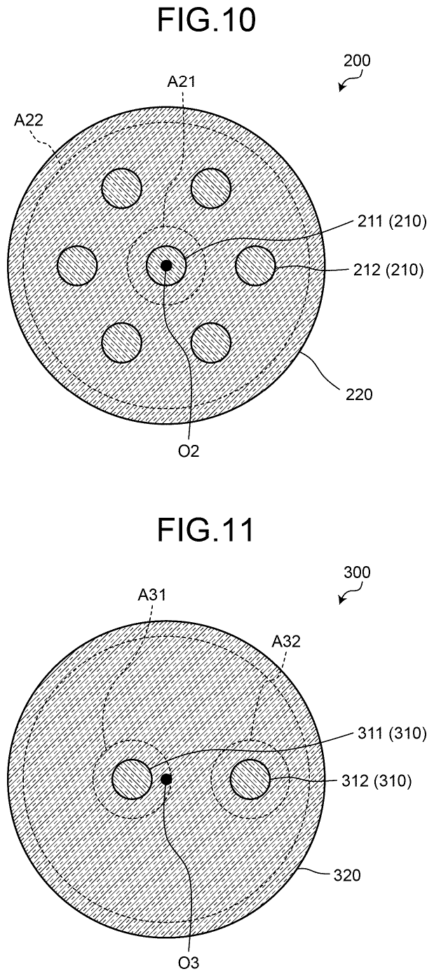

FIG. 11 is a schematic sectional view for a cross section perpendicular to a longitudinal direction of an optical fiber 300A connected in an optical fiber connection structure according to a third embodiment. The optical fiber 300A is a multicore fiber made of silica-based glass and includes two cores 310 and common cladding 320 surrounding outer peripheries of the cores 310. The two cores 310 are an example of plural cores. The cores 310 have an additive, such as germanium, added therein, to increase their refractive index in relation to the cladding 320. The optical fiber 300A is also called a 2-core multicore fiber.

The cladding 320 has areas A31 and A32 prescribed on any cross section perpendicular to the longitudinal direction of the optical fiber 300A. The area A31 is a circular area nearest to a central axis O3 of the optical fiber 300A, the central axis O3 also being a central axis of the cladding 320, the circular area including the central axis O3. The area A32 is a circular area that is farther from the central axis O3 than the area A31.

The cores 310 include cores 311 and 312. Specifically, the core 311 is present in the area A31 and the core 212 is present in the area A32.

The optical fiber connection structure according to the third embodiment has the optical fiber 300A illustrated in FIG. 11 and an optical fiber having the same configuration as the optical fiber 300A connected to each other at their end faces by fusion splicing. The optical fiber 300A and the optical fiber connected to the optical fiber 300A by fusion splicing have the same configuration and arrangements of their cores thus match each other.

In a connection region near the end faces connected by fusion splicing in the optical fiber connection structure according to the third embodiment also, their cores 312 present in their areas A32 have mode field diameters larger than mode field diameters of their core 311 present in their areas A31. In this case, the areas A31 are an example of first areas and the areas A32 are an example of second areas, the cores 311 are an example of first cores, and the cores 312 are an example of second cores.

However, in a region farther from a connection portion than the connection region is in the optical fiber connection structure according to the third embodiment, the cores 310 have approximately equal mode field diameters.

In the optical fiber connection structure according to the third embodiment also, similarly to the first and second embodiments, the difference between the connection losses is able to be reduced even for cores at different radial distances from the central axis.

In the above described embodiments, optical fibers having the same configuration and core arrangements matching each other are connected to each other but optical fibers having core arrangements matching each other partly may be connected to each other. For example, the present disclosure is also applicable to a case where the optical fiber 100A illustrated in FIG. 1 and an optical fiber having the configuration of the optical fiber 100A but the core 111 removed therefrom are connected to each other.

Furthermore, both the first optical fiber and the second fiber are multicore fibers in the above described embodiments, but at least one of the first optical fiber and the second optical fiber may be a bundle-type optical fiber. That is, one of the first optical fiber and the second optical fiber may be a multicore fiber and the other one thereof may be a bundle-type optical fiber, or both the first optical fiber and the second optical fiber may be bundle-type optical fibers.

According to the present disclosure, the difference between the connection losses is able to be reduced even for cores at different distances in the radial direction from the central axis.

Furthermore, the present disclosure is not to be limited by the above described embodiments. Those configured by combination of the components described above as appropriate are also included in the present disclosure. In addition, further effects and modifications can be readily derived by those skilled in the art. Therefore, wider aspects of the present disclosure are not limited to the above described embodiments and various modifications can be made.

What is claimed is:

1. An optical fiber connection structure, comprising
a first optical fiber and a second optical fiber each including plural cores and a cladding surrounding outer peripheries of the plural cores, the first optical fiber and the second optical fiber being connected to each other at end faces of the first optical fiber and the second optical fiber, arrangements of the plural cores of the first optical fiber and the second optical fiber matching each other at least partly, wherein
the plural cores include a first core and a second core that is farther from a central axis of the cladding than the first core, and
the second core has a mode field diameter larger than a mode field diameter of the first core in at least a connection region near the end faces.

2. The optical fiber connection structure according to claim 1, wherein in the connection region, a range where an additive included in the second core to increase a refractive index of the second core is present in a radial direction of the second core is wider than a range where an additive included in the first core to increase a refractive index of the first core is present in a radial direction of the first core.

3. The optical fiber connection structure according to claim 1, wherein
at a wavelength of 1550 nm, Expression 1 below holds in at least a range of 6 μm≤MFD≤16 μm where MFD is a mode field diameter of the cores in micrometers, r is a core pitch in micrometers, x is a relative rotation error about a central axis between the first optical fiber and the second optical fiber in degrees, e is a base of natural logarithms, and Loss is a connection loss in the cores in decibels.
$$MFD \geq 2 √ ( ( 10 / Loss ) \cdot log ( e ) ) \cdot ( π \cdot r \cdot x / 180 ) \qquad ( 1 )$$

4. The optical fiber connection structure according to claim 1, wherein
at a wavelength of 1550 nm, Expressions 2 and 3 below hold in at least a range of 6 μm≤MFD1<MFD2≤16 μm where MFD1 is the mode field diameter of the first core in micrometers, MFD2 is the mode field diameter of the second core in micrometers, r is a core pitch in the first optical fiber and the second optical fiber in micrometers, x is a relative rotation error about a central axis between the first optical fiber and the second optical fiber in degrees, and e is a base of natural logarithms, and
a distance from the central axis of the cladding to a central axis of the second core is twice a distance from the central axis of the cladding to a central axis of the first core.
$$MFD 1 \geq 2 √ ( ( 10 / 1.5 ) \cdot log ( e ) ) \cdot ( π \cdot r \cdot x / 180 ) \qquad ( 2 )$$
$$MFD 2 \geq 4 √ ( ( 10 / 1.5 ) \cdot log ( e ) ) \cdot ( π \cdot r \cdot x / 180 ) \qquad ( 3 )$$

5. The optical fiber connection structure according to claim 4, wherein the MFD2 is 1.8 times the MFD1 or larger and 2.2 times the MFD1 or smaller.

6. The optical fiber connection structure according to claim 1, wherein the first optical fiber or the second optical fiber is a multicore fiber.

7. The optical fiber connection structure according to claim 1, wherein the first optical fiber or the second optical fiber is a bundle-type optical fiber.

8. A method of manufacturing the optical fiber connection structure according to claim 1, the method comprising:
a process of causing an end face of the first optical fiber and an end face of the second optical fiber to face each other and performing electric discharge near the end faces faced each other, wherein
in the performing the electric discharge, a range where an additive included in the second core to increase a refractive index of the second core is diffused in a radial direction of the second core is made wider than a range where an additive included in the first core to increase a refractive index of the first core is diffused in a radial direction of the first core.

9. The method of manufacturing the optical fiber connection structure, according to claim 8, wherein intermittent discharge is performed in the performing the electric discharge.

10. The method of manufacturing the optical fiber connection structure, according to claim 8, wherein in the performing the electric discharge, a pair of electrodes for the electric discharge are caused to reciprocate in a direction orthogonal to a longitudinal direction of the first optical fiber and the second optical fiber such that thermal energy to be imparted to a region near central axes of the first optical fiber and the second optical fiber is made less than thermal energy to be imparted to a position away from the central axes of the first optical fiber and the second optical fiber in a reciprocating direction of the pair of electrodes.

11. The method of manufacturing the optical fiber connection structure, according to claim 8, wherein in the performing the electric discharge, a group of three or more electrodes for the electric discharge are arranged to surround the end faces of the first optical fiber and the second optical fiber to perform the electric discharge, the end faces having been faced each other.

12. The method of manufacturing the optical fiber connection structure, according to claim 11, wherein intermittent discharge is performed in the electric discharge.

13. The method of manufacturing the optical fiber connection structure, according to claim 11, wherein an electric discharge intensity in the electric discharge has a temporal periodicity.
